(19) United States
(12) Patent Application Publication
(10) Pub. No.: US 2025/0343276 A1
(43) Pub. Date: Nov. 6, 2025

(54) NON-AQUEOUS ELECTROLYTE SECONDARY BATTERY

(71) Applicant: Panasonic Energy Co., Ltd., Moriguchi-shi, Osaka (JP)

(72) Inventors: Shinji Kasamatsu, Osaka (JP); Sota Fukuda, Tokushima (JP)

(73) Assignee: Panasonic Energy Co., Ltd., Moriguchi-shi, Osaka (JP)

(21) Appl. No.: 18/867,541

(22) PCT Filed: May 22, 2023
(86) PCT No.: PCT/JP2023/018873

§ 371 Date: Nov. 20, 2024

(30) Foreign Application Priority Data
May 31, 2022 (JP) 2022-088482

(51) Int. Cl. H01M 10/0587; H01M 50/107; H01M 50/431; H01M 50/443

(52) U.S. Cl. CPC H01M 10/0587; H01M 50/107; H01M 50/431; H01M 50/443

(57) ABSTRACT

Provided is a non-aqueous electrolyte secondary battery in which plastic deformation of a separator is suppressed. A non-aqueous electrolyte secondary battery comprises an electrode body formed by winding a positive electrode and a negative electrode with a separator therebetween; a non-aqueous electrolyte; and an outer can for accommodating therein the electrode body and the non-aqueous electrolyte. The separator has a base material layer and a filler layer formed at least on one surface of the base material layer. The filler layer contains first inorganic particles and second inorganic particles having a larger average particle diameter than the first inorganic particles, and has protruding parts formed from the second inorganic particles. When the surface of the filler layer is observed by a scanning electron microscope, 10-35 particles of the second inorganic particles forming the protruding parts are detected in a range of 100 μm×100 μm.

### TECHNICAL FIELD

The present disclosure relates to a non-aqueous electrolyte secondary battery.

### BACKGROUND ART

In recent years, non-aqueous electrolyte secondary batteries have been widely used as secondary batteries with high output and high energy density. In the non-aqueous electrolyte secondary battery, charge and discharge are performed by transferring lithium ions and the like between a positive electrode and a negative electrode through a non-aqueous electrolyte. The positive electrode and the negative electrode face each other via a separator, and the separator separates the positive electrode and the negative electrode each other.

Patent Literature 1 discloses a separator comprising a porous substrate layer and a heat-resistant filler layer. This separator contains a filler having a relatively large particle diameter in the filler layer to have numerous depressions and projections on a surface of the filler layer. Patent Literature 1 describes that the numerous depressions and projections formed on the surface of the filler layer can hold an electrolytic solution between the separator and an electrode.

### CITATION LIST

### Patent Literature

PATENT LITERATURE 1: Japanese Unexamined Patent Application Publication No. 2015-76289

### SUMMARY

The secondary battery may suffer from decrease in battery capacity with repeated charge and discharge. The present inventors have made intensive investigation and consequently found that increase or decrease in electrode thickness due to charge and discharge causes plastic deformation and thinning of the separator, leading to changes in distance between the electrodes and decreased battery capacity. The plastic deformation of the separator may affect battery characteristics other than the battery capacity. In addition, the plastic deformation of the separator is desired to be inhibited from the viewpoint of safety. The art disclosed in Patent Literature 1 does not investigate the plastic deformation of the separator, and still has room for improvement.

An object of the present disclosure is to provide a non-aqueous electrolyte secondary battery with inhibited plastic deformation of the separator.

A non-aqueous electrolyte secondary battery of an aspect of the present disclosure comprises: an electrode assembly in which a positive electrode and a negative electrode are wound with a separator interposed therebetween; a non-aqueous electrolyte; and an exterior housing can that houses the electrode assembly and the non-aqueous electrolyte, wherein the separator has a substrate layer and a filler layer formed on at least one surface of the substrate layer, the filler layer includes first inorganic particles and second inorganic particles having an average particle diameter larger than that of the first inorganic particles, and has projections formed with the second inorganic particles, and when a surface of the filler layer is observed with a scanning electron microscope, greater than or equal to 10 and less than or equal to 35 of the second inorganic particles forming the projections are detected in a region of 100 μm×100 μm.

According to the non-aqueous electrolyte secondary battery of the present disclosure, the plastic deformation of the separator can be inhibited. This can improve the battery characteristics such as charge-discharge cycle characteristics and safety of the non-aqueous electrolyte secondary battery.

### BRIEF DESCRIPTION OF DRAWING

FIG. 1 is a vertical sectional view of a cylindrical secondary battery of an example of an embodiment.

FIG. 2 is a sectional view of a separator of an example of an embodiment.

### DESCRIPTION OF EMBODIMENTS

Hereinafter, an example of an embodiment of a non-aqueous electrolyte secondary battery according to the present disclosure will be described in detail with reference to the drawings. Hereinafter, a cylindrical secondary battery in which an electrode assembly is housed in a cylindrical exterior housing can will be exemplified, but the exterior housing can is not limited to the cylindrical exterior housing can, and may be a rectangular exterior housing can, a coin-shaped exterior housing can, or the like, for example. In the following description, specific shapes, materials, values, directions, and the like, which are examples for facilitating understanding of the present disclosure, may be appropriately modified with specifications of non-aqueous electrolyte secondary batteries. When a plurality of embodiments and modified examples are included in the following description, use in appropriate combination of characteristic portions thereof is anticipated in advance.

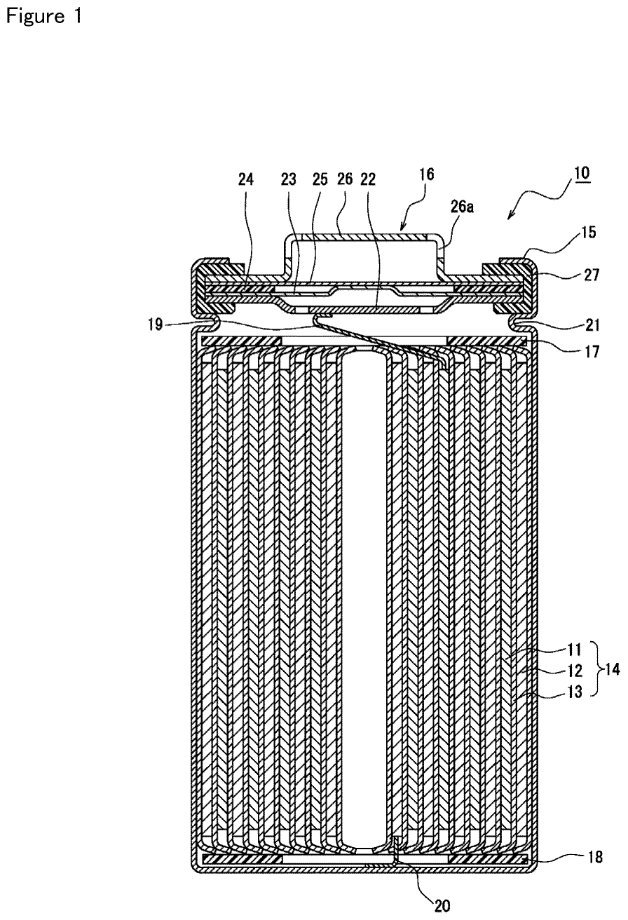

FIG. 1 is a vertical sectional view of a cylindrical secondary battery 10 of an example of an embodiment. In the cylindrical secondary battery 10 illustrated in FIG. 1, an electrode assembly 14 and a non-aqueous electrolyte (not illustrated) are housed in an exterior housing can 15. Hereinafter, for convenience of description, a direction along an axial direction of the exterior housing can 15 will be described as “the vertical direction or the upper-lower direction”, a side of a sealing assembly 16 will be described as “the upper side”, and a side of a bottom of the exterior housing can 15 will be described as “the lower side”.

As a non-aqueous solvent (organic solvent) of the non-aqueous electrolyte, carbonates, lactones, ethers, ketones, esters, and the like may be used, and two or more of these solvents may be mixed for use. When two or more of the solvents are mixed for use, a mixed solvent including a cyclic carbonate and a chain carbonate is preferably used. For example, ethylene carbonate (EC), propylene carbonate (PC), butylene carbonate (BC), or the like may be used as the cyclic carbonate, and dimethyl carbonate (DMC), ethyl methyl carbonate (EMC), diethyl carbonate (DEC), or the like may be used as the chain carbonate. As the esters, carbonate esters such as methyl acetate (MA) and methyl propionate (MP) are preferably used. The non-aqueous solvent may contain a halogen-substituted derivative in which hydrogen atoms of these solvents are at least partially substituted with a halogen atom such as fluorine. As the halogen-substituted derivative, fluoroethylene carbonate (FEC), methyl fluoropropionate (FMP), and the like are preferably used, for example. As an electrolyte salt in the non-aqueous electrolyte, LiPF₆, LiBF₄, LiCF₃SO₃, lithium bis(fluorosulfonyl)imide, lithium bis(trifluoromethanesulfonyl)imide, and the like, and a mixture thereof may be used. The amount of the electrolyte salt to be dissolved in the non-aqueous solvent is, for example, greater than or equal to 0.5 mol/L and less than or equal to 2.0 mol/L.

The electrode assembly 14 has a wound structure in which a band-shaped positive electrode 11 and a band-shaped negative electrode 12 are wound with a separator 13 interposed therebetween. All of the positive electrode 11, negative electrode 12, and separator 13 have an elongated band-shape, and are spirally wound to be alternately stacked in a radial direction of the electrode assembly 14. In the electrode assembly 14, the positive electrode 11, the negative electrode 12, and the separator 13 are wound with greater than or equal to 10 rounds and less than or equal to 30 rounds, for example. To prevent precipitation of lithium, the negative electrode 12 is formed to be one size larger than the positive electrode 11. That is, the negative electrode 12 is formed to be longer than the positive electrode 11 in a longitudinal direction and a width direction (short direction). Two of the separators 13 are formed to be one size larger than the positive electrode 11 and the negative electrode 12, and disposed to sandwich the positive electrode 11. A positive electrode lead 19 is connected to a substantial center in the longitudinal direction of the positive electrode 11 by welding or the like, and a negative electrode lead 20 is connected to an inner end of winding of the negative electrode 12 by welding or the like.

Insulating plates 17 and 18 are respectively disposed on the upper and lower sides of the electrode assembly 14. In the example illustrated in FIG. 1, the positive electrode lead 19 extends through a through hole in the insulating plate 17 toward a side of the sealing assembly 16, and is connected to a lower surface of a filter 22 of the sealing assembly 16 by welding or the like. In the secondary battery 10, a cap 26, which is a top plate of the sealing assembly 16 electrically connected to the filter 22, becomes a positive electrode terminal. On the other hand, the negative electrode lead 20 extends through a through hole of the insulating plate 18 toward the bottom side of the exterior housing can 15, and is connected to a bottom inner face of the exterior housing can 15 by welding or the like. In the secondary battery 10, the exterior housing can 15 becomes a negative electrode terminal. When the negative electrode lead 20 is provided on an outer end of winding, the negative electrode lead 20 extends through an outside of the insulating plate 18 toward the bottom side of the exterior housing can 15, and welded to a bottom inner face of the exterior housing can 15.

As noted above, the exterior housing can 15 is a bottomed cylindrical metallic container with an opening on one side in the axial direction. A gasket 27 is provided between the exterior housing can 15 and the sealing assembly 16 to achieve sealability inside the battery and insurability between the exterior housing can 15 and the sealing assembly 16. On the exterior housing can 15, a grooved portion 21 in which a part of a side wall projects inward to support the sealing assembly 16 is formed. The grooved portion 21 is preferably formed in a circular shape along a circumferential direction of the exterior housing can 15, and supports the sealing assembly 16 with the upper face thereof. The sealing assembly 16 is fixed on the upper part of the exterior housing can 15 with the grooved portion 21 and with an end of the opening of the exterior housing can 15 caulked with the sealing assembly 16.

The sealing assembly 16 has a stacked structure of the filter 22, a lower vent member 23, an insulating member 24, an upper vent member 25, and the cap 26 in this order from the electrode assembly 14 side. Each member constituting the sealing assembly 16 has, for example, a disk shape or a ring shape, and each member except for the insulating member 24 is electrically connected to each other. The lower vent member 23 and the upper vent member 25 are connected at each of central parts thereof, and the insulating member 24 is interposed between each of the circumferential parts. If the internal pressure increases due to battery abnormality, the lower vent member 23 is deformed so as to push the upper vent member 25 up toward the cap 26 side and breaks, and thereby a current pathway between the lower vent member 23 and the upper vent member 25 is cut off. If the internal pressure further increases, the upper vent member 25 breaks, and gas is discharged through an opening 26a of the cap 26.

Hereinafter, the positive electrode 11, the negative electrode 12, and the separator 13 that constitute the electrode assembly 14, specifically the separator 13, will be described in detail.

### Positive Electrode

The positive electrode 11 has a positive electrode current collector and a positive electrode mixture layer formed on a surface of the positive electrode current collector. For the positive electrode current collector, a foil of a metal stable within a potential range of the positive electrode, such as aluminum, a film in which such a metal is disposed on a surface layer, or the like may be used. A thickness of the positive electrode current collector is, for example, greater than or equal to 10 μm and less than or equal to 30 μm.

The positive electrode mixture layer is preferably formed on both surfaces of the positive electrode current collector. A thickness of the positive electrode mixture layer is, for example, greater than or equal to 10 μm and less than or equal to 150 μm on one side of the positive electrode current collector. The positive electrode mixture layer includes, for example, a positive electrode active material, a conductive agent, and a binder. The positive electrode may be produced by, for example, applying a positive electrode mixture slurry including the positive electrode active material, the conductive agent, the binder, and the like on both the surfaces of the positive electrode current collector, drying the coating, and subsequently rolling the coating by using a roller or the like.

Examples of the positive electrode active material included in the positive electrode mixture layer may include a lithium-transition metal composite oxide containing a transition metal element such as Co, Mn, and Ni. The lithium-transition metal composite oxide is, for example, LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄, LiMPO₄, and Li₂MPO₄F (M; at least one of Na, Mg, Sc, Y, Mn, Fe, Co, Ni, Cu, Zn, Al, Cr, Pb, Sb, and B, 0<x≤1.2, 0<y≤0.9, and 2.0≤z≤2.3). These may be used singly, or as a mixture thereof.

In terms of increase in the capacity of the non-aqueous electrolyte secondary battery, the positive electrode active material preferably includes a lithium-nickel composite oxide. Examples of the lithium-nickel composite oxide may include LiₓNiO₂, LiₓCo_{y}Ni_{1-y}O₂, and LiₓNi_{1-y}M_{y}O_{z}, wherein M represents at least one of Na, Mg, Sc, Y, Mn, Fe, Co, Ni, Cu, Zn, Al, Cr, Pb, Sb, and B, 0<x≤1.2, 0<y≤0.9, and 2.0≤z≤2.3. A lithium-nickel composite oxide having a higher content rate of Ni has higher capacity.

Examples of the conductive agent included in the positive electrode mixture layer include carbon-based particles such as carbon black (CB), acetylene black (AB), Ketjenblack, carbon nanotube (CNT), graphene, and graphite. These may be used singly, or in combination of two or more.

Examples of the binder included in the positive electrode mixture layer include fluororesins such as polytetrafluoroethylene (PTFE) and polyvinylidene fluoride (PVDF), polyacrylonitrile (PAN), polyimide resins, acrylic resins, and polyolefin resins. These may be used singly, or in combination of two or more.

### Negative Electrode

The negative electrode 12 has a negative electrode current collector and a negative electrode mixture layer formed on a surface of the negative electrode current collector. For the negative electrode current collector, a foil of a metal stable within a potential range of the negative electrode, such as copper, a film in which such a metal is disposed on a surface layer, or the like may be used. A thickness of the negative electrode current collector is, for example, greater than or equal to 5 μm and less than or equal to 30 μm.

The negative electrode mixture layer is preferably formed on both surfaces of the negative electrode current collector. A thickness of the negative electrode mixture layer is, for example, greater than or equal to 10 μm and less than or equal to 150 μm on one side of the negative electrode current collector. The negative electrode mixture layer includes, for example, a negative electrode active material and a binder. The negative electrode may be produced by, for example, applying a negative electrode mixture slurry including the negative electrode active material, the binder, and the like on both the surfaces of the negative electrode current collector, drying the coating, and subsequently rolling the coating by using a roller or the like.

The negative electrode active material included in the negative electrode mixture layer is not particularly limited as long as it may reversibly occlude and release lithium ions, and a carbon material such as graphite is typically used. The graphite may be any of: a natural graphite such as flake graphite, massive graphite, and amorphous graphite; and an artificial graphite such as massive artificial graphite and graphitized mesophase-carbon microbead.

As the negative electrode active material, a metal that forms an alloy with Li, such as Si or Sn, a metal compound including Si, Sn, or the like, a lithium-titanium composite oxide, or the like may be used. For example, a Si-containing compound represented by SiOₓ (0.5≤x≤1.6); or a Si-containing compound in which Si fine particles are dispersed in a lithium silicate phase represented by Li_{2y}SiO_{(2+y)}(0<y<2) may be used in combination with graphite.

Since the Si-containing compound expands and contracts to a large degree due to charge and discharge of the battery, the separator 13 is likely to undergo plastic deformation when the negative electrode 12 includes the Si-containing compound. Thus, when the negative electrode 12 includes the Si-containing compound, an effect by the separator 13 described later becomes remarkable.

Examples of the binder included in the negative electrode mixture layer include styrene-butadiene rubber (SBR), nitrile-butadiene rubber (NBR), carboxymethylcellulose (CMC) or a salt thereof, polyacrylic acid (PAA) or a salt thereof (which may be PAA-Na, PAA-K, and the like, or a partially neutralized salt), and polyvinyl alcohol (PVA). These materials may be used singly, or in combination of two or more.

### Separator

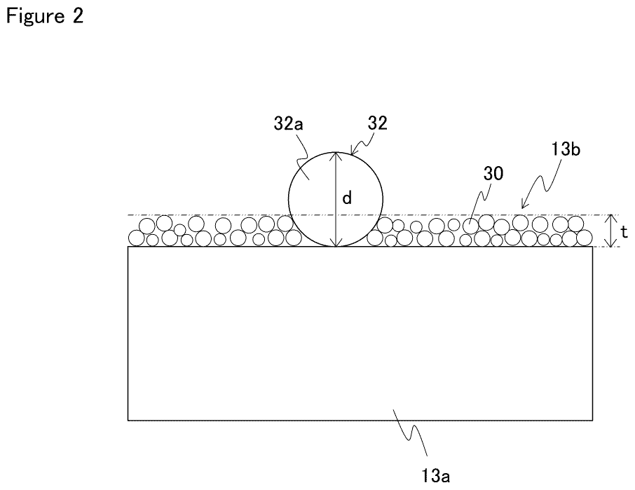

The separator 13 separates the positive electrode 11 and the negative electrode 12 from each other, and inhibits contact between the positive electrode 11 and the negative electrode 12 to cause short circuit. FIG. 2 is a sectional view of the separator 13 of an example of an embodiment. In the example illustrated in FIG. 2, the positive electrode 11 is disposed on the upper side of the separator 13, and the negative electrode 12 is disposed on the lower side.

As illustrated in FIG. 2, the separator 13 has a substrate layer 13a and a filler layer 13b formed on at least one surface of the substrate layer 13a. In the present embodiment, the filler layer 13b faces the positive electrode 11, and the substrate layer 13a faces the negative electrode 12. The separator 13 is not limited to this example, and the filler layer 13b may face the negative electrode 12, and the substrate layer 13a may face the positive electrode 11. The separator 13 may have the filler layer 13b on both the surfaces of the substrate layer 13a.

As the substrate layer 13a, a porous sheet having an ion permeation property and an insulation property is used, for example. Specific examples of the porous sheet include a fine porous thin film, a woven fabric, and a nonwoven fabric. A material of the substrate layer 13a is not particularly limited, and examples thereof may include polyolefins such as polyethylene, polypropylene, and a copolymer of polyethylene and an α-olefin, an acrylic resin, polystyrene, a polyester, cellulose, a polyimide, polyphenylene sulfide, polyether ether ketone, and a fluororesin. The substrate layer 13a may have a single-layered structure, or may have a stacked structure. A thickness of the substrate layer 13a is preferably greater than or equal to 3 μm and less than or equal to 20 μm, and more preferably greater than or equal to 5 μm and less than or equal to 15 μm.

The filler layer 13b includes first inorganic particles 30 and second inorganic particles 32 having an average particle diameter larger than that of the first inorganic particles 30, and has projections 32a formed with the second inorganic particles 32. When a surface of the filler layer 13b is observed with a scanning electron microscope (SEM, for example, SU8220, manufactured by Hitachi High-Tech Corporation), greater than or equal to 10 and less than or equal to 35 of the second inorganic particles 32 forming the projections 32a are detected in a region of 100 μm×100 μm. According to this, internal stress generated by expansion and contraction of the positive electrode 11 and the negative electrode 12 in charge and discharge of the secondary battery 10 can be relaxed, and thereby the plastic deformation of the separator 13 can be inhibited.

If the number of the detected second inorganic particles 32 forming the projections 32a per predetermined area (100 μm×100 μm) is less than 10, the filler layer 13b adheres to the electrode, and the effect of inhibiting the plastic deformation of the separator 13 is not sufficiently exhibited. If the number of the detected second inorganic particles 32 forming the projections 32a is greater than 35, there is no sufficient space between the projections 32a, and the effect of inhibiting the plastic deformation of the separator 13 is not sufficiently exhibited.

The projections 32a have, for example, a size so as to be detectable by SEM observation with magnifying the surface of the filler layer 13b with 1000 times. In the surface of the filler layer 13b, a region of 100 μm×100 μm is observed to count the number of the second inorganic particles 32 forming the projections 32a detected by the SEM observation. The observation is performed in different three regions, and an average value of the numbers detected in the regions is specified as the number of the second inorganic particles forming the projections per predetermined area (100 μm×100 μm).

As illustrated in FIG. 2, the second inorganic particles 32 forming the projections 32a preferably contact with the surface of the substrate layer 13a. The surface of a portion excluding the projections 32a in the filler layer 13b is preferably substantially flat, and the thickness “t” is, for example, greater than or equal to 1 μm and less than or equal to 5 μm. An average height of the projections 32a is preferably greater than or equal to 1 μm and less than or equal to 9 μm relative to a surface of a part adjacent to the projections 32a in the filler layer 13b. When the surface of the portion excluding the projections 32a in the filler layer 13b is flat and when a particle diameter of the second inorganic particle 32 in a thickness direction of the separator 13 is “d”, the height of the projection 32a can be calculated by subtracting “t” from “d”. The average height of the projections 32a is obtained by averaging heights of all the projections 32a in the predetermined area (100 μm×100 μm). The average height of the projections 32a can be measured by using a shape analysis laser microscope (for example, VK-X1000, manufactured by KEYENCE CORPORATION). A sectional shape of the second inorganic particles 32 may be a circular shape or an oval shape, and is not particularly limited.

Examples of a material of the first inorganic particles 30 include a metal oxide, a metal nitride, a metal fluoride, and a metal carbide. Examples of the metal oxide include aluminum oxide, titanium oxide, magnesium oxide, zirconium oxide, nickel oxide, silicon oxide, and manganese oxide. Examples of the metal nitride include titanium nitride, boron nitride, aluminum nitride, magnesium nitride, and silicon nitride. Examples of the metal fluoride include aluminum fluoride, lithium fluoride, sodium fluoride, magnesium fluoride, calcium fluoride, and barium fluoride. Examples of the metal carbide include silicon carbide, boron carbide, titanium carbide, and tungsten carbide. The first inorganic particles 30 may also be a porous aluminosilicate salt such as zeolite (M_{2/n}O·Al₂O₃·xSiO₂·yH₂O, wherein M represents a metal element, n represents a valency of M, x≥2, and y≥0), a layered silicate salt such as talc (Mg₃Si₄O₁₀(OH)₂), and minerals such as barium titanate (BaTiO₃) and strontium titanate (SrTiO₃). These may be used singly, or may be used in combination of two or more thereof.

A material of the second inorganic particles 32 preferably has rigidity such that the shape can be retained even when internal stress is generated inside the electrode assembly 14, stability against the non-aqueous electrolyte, and electrochemical stability of not contributing to the charge-discharge reactions. The material of the second inorganic particles 32 is at least one selected from the group consisting of an oxide, a sulfate, and a hydroxide. Examples of the oxide include alumina, silica, titania, zirconia, and magnesia. Examples of the sulfide include barium sulfate, magnesium sulfate, and aluminum sulfate. Examples of the hydroxide include aluminum hydroxide, magnesium hydroxide, and aluminum hydroxide.

An average particle diameter (D50) of the first inorganic particles 30 is, for example, greater than or equal to 0.3 μm and less than or equal to 0.8 μm, and D50 of the second inorganic particles 32 is, for example, greater than or equal to 3 μm and less than or equal to 10 μm. The average particle diameter (D50) herein means a particle diameter at which a cumulative frequency is 50% from a smaller particle diameter side in volume-based particle size distribution, and also referred to as “median diameter”. The particle size distribution of the inorganic particles may be measured by using a laser diffraction-type particle size distribution measuring device (for example, MT3000II, manufactured by MicrotracBEL Corp.) with water as a dispersion medium.

The filler layer 13b may further include a binder. The binder is a material that can form a film on the substrate layer 13a. The binder has a function of adhesion of the first inorganic particles 30 and the second inorganic particles 32 to the substrate layer 13a. The binder is preferably a polymer material, and examples thereof may include fluororesins such as polyvinylidene fluoride (PVDF) and polytetrafluoroethylene (PTFE), polyimide resins, polyamide resins, acrylic resins, polyolefin resins, styrene-butadiene rubber (SBR), nitrile-butadiene rubber (NBR), carboxymethylcellulose (CMC) or a salt thereof, polyacrylic acid (PAA) or a salt thereof, and polyvinyl alcohol (PVA). These may be used singly, or in combination of two or more.

In the filler layer 13b, a content of the second inorganic particles 32 is, for example, greater than or equal to 1 part by mass and less than or equal to 10 parts by mass, and a content of the binder is, for example, greater than or equal to 1 part by mass and less than or equal to 10 parts by mass when the content of the first inorganic particles 30 is 100 parts by mass.

### EXAMPLES

Hereinafter, the present disclosure will be further described with Examples, but the present disclosure is not limited to these Examples.

### Example

### Production of Positive Electrode

As a positive electrode active material, aluminum-containing lithium nickel cobaltate represented by LiNi_{0.88}Co_{0.09}Al_{0.03}O₂ was used. 100 parts by mass of positive electrode active material, 1 part by mass of acetylene black (AB), and 0.9 part by mass of polyvinylidene fluoride (PVDF) were mixed, and an appropriate amount of N-methyl-2-pyrrolidone (NMP) was added to prepare a positive electrode mixture slurry. Then, this positive electrode mixture slurry was applied to both surfaces of a band-shaped positive electrode current collector made of aluminum foil and having a thickness of 15 μm, the coating was dried and subsequently rolled, and cut to a predetermined electrode size to produce a positive electrode in which positive electrode mixture layers were formed on both the surfaces of the positive electrode current collector. On a substantial center in a longitudinal direction of the positive electrode, a positive electrode exposed portion where the mixture layer was absent and the current collector surface was exposed was provided, and a positive electrode lead made of aluminum was welded with the positive electrode exposed portion.

### Production of Negative Electrode

Mixing 95 parts by mass of graphite, 5 parts by mass of Si oxide (SiO), 1 part by mass of sodium carboxymethylcellulose (CMC-Na), and 1 part by mass of styrene-butadiene rubber (SBR) was performed, and an appropriate amount of water was added to prepare a negative electrode mixture slurry. Then, this negative electrode mixture slurry was applied to both surfaces of a band-shaped negative electrode current collector made of copper foil and having a thickness of 8 μm, the coating was dried and subsequently rolled, and cut to a predetermined electrode size to produce a negative electrode in which negative electrode mixture layers were formed on both the surfaces of the negative electrode current collector. On an inner end of winding of the negative electrode, a negative electrode exposed portion where the mixture layer was absent and the current collector surface was exposed was provided, and a negative electrode lead made of nickel was welded with the negative electrode exposed portion.

### Production of Separator

As a substrate layer, a porous substrate made of polyethylene with a thickness of 12 μm was used. Alumina (α-Al₂O₃) particles having an average particle diameter (D50) of 0.7 μm as first inorganic particles, magnesium hydroxide (Mg(OH)₂) particles having D50 of 5 μm as second inorganic particles, and an acrylate ester-based binder emulsion were mixed at a solid-content mass ratio of 100:4:3, and then an appropriate amount of water was added so that the solid-content concentration was 10 mass % to prepare a dispersion. This dispersion was applied on an entire surface of the porous substrate as the substrate layer by using a micro gravure coater. Thereafter, the coating film was heated and dried with an oven at 50° C. for 4 hours to form a filler layer having the Mg(OH)₂ particles projected from a surface of the binder with a thickness of 3 μm. As a result of observation using a scanning electron microscope (SU8220, manufactured by Hitachi High-Tech Corporation), the number of the second inorganic particles forming the projections per predetermined area (100 μm×100 μm) was 10. An average height of the projections was 2 μm.

### Preparation of Non-Aqueous Electrolyte

Into 100 parts by mass of a mixed solvent in which ethylene carbonate (EC) and dimethyl carbonate (DMC) were mixed at a volume ratio of 3:7, 5 parts by mass of vinylene carbonate (VC) was added, and lithium hexafluorophosphate (LiPF₆) was dissolved at a concentration of 1.5 mol/L to prepare a non-aqueous electrolyte.

### Production of Secondary Battery

The positive electrode and the negative electrode were spirally wound with the separator interposed therebetween to produce a wound electrode assembly. In this time, the filler layer of the separator faced the positive electrode. Insulating plates were respectively disposed on the upper and lower sides of the electrode assembly, and the electrode assembly was housed in an exterior housing can. A negative electrode lead was welded to a bottom of the bottomed cylindrical exterior housing can, and a positive electrode lead was welded to a sealing assembly. The non-aqueous electrolyte was injected into the exterior housing can, then an opening of the exterior housing can was sealed with the sealing assembly via a gasket, and then left to stand in a thermostatic chamber at 60° C. for 15 hours to produce a non-aqueous electrolyte secondary battery. A capacity of the produced secondary battery was 4600 mAh.

### Evaluation of Changing Rate of Separator Thickness

The secondary battery was charged at a constant current of 1380 mA (0.3 It) until a battery voltage reached 4.2 V, and then charged at a constant voltage of 4.2 V until a current reached 92 mA (0.02 It). Thereafter, the battery was discharged at a constant current of 4600 mA (1.0 It) until the battery voltage reached 2.7 V. This charge-discharge cycle was performed with 500 cycles with inserting a rest time for 20 minutes between each of the cycles. The secondary battery after the 500 cycles was disassembled to take out the separator. A thickness of this separator was measured at a position of ⅓ from an end of inner winding of an entire length in a longitudinal direction, and the measured value was specified as “thickness after cycles”. From the “thickness after cycles” and “initial thickness” of the separator measured in advance before assembling the secondary battery, a changing rate of the separator thickness was calculated with the following calculation formula.

Changing ratio of separator thickness (%)=(Initial thickness-Thickness after cycles)/(Initial thickness)×100

### Example 2

A secondary battery was produced and evaluated in the same manner as in Example 1 except that, in the production of the separator, the mixing ratio of the Mg(OH)₂ particles relative to 100 parts by mass of the α-Al₂O₃ particles was changed to 7 parts by mass. As a result of the SEM observation, the number of the second inorganic particles forming the projections per predetermined area (100 μm×100 μm) was 16. An average height of the projections was 2 μm.

### Example 3

A secondary battery was produced and evaluated in the same manner as in Example 1 except that, in the production of the separator, the mixing ratio of the Mg(OH)₂ particles relative to 100 parts by mass of the α-Al₂O₃ particles was changed to 14 parts by mass. As a result of the SEM observation, the number of the second inorganic particles forming the projections per predetermined area (100 μm×100 μm) was 35. An average height of the projections was 2 μm.

### Example 4

A secondary battery was produced and evaluated in the same manner as in Example 1 except that, in the production of the separator, Mg(OH)₂ particles having D50 of 4 μm were used instead of the Mg(OH)₂ particles having D50 of 5 μm, and the mixing ratio of the Mg(OH)₂ particles relative to 100 parts by mass of the α-Al₂O₃ particles was changed to 14 parts by mass. As a result of the SEM observation, the number of the second inorganic particles forming the projections per predetermined area (100 μm×100 μm) was 26. An average height of the projections was 2 μm. An average height of the projections was 1 μm.

### Example 5

A secondary battery was produced and evaluated in the same manner as in Example 1 except that, in the production of the separator, Mg(OH)₂ particles having D50 of 7 μm were used instead of the Mg(OH)₂ particles having D50 of 5 μm, and the mixing ratio of the Mg(OH)₂ particles relative to 100 parts by mass of the α-Al₂O₃ particles was changed to 30 parts by mass. As a result of the SEM observation, the number of the second inorganic particles forming the projections per predetermined area (100 μm×100 μm) was 28. An average height of the projections was 4 μm.

### Example 6

A secondary battery was produced and evaluated in the same manner as in Example 1 except that, in the production of the separator, Mg(OH)₂ particles having D50 of 10 μm were used instead of the Mg(OH)₂ particles having D50 of 5 μm, and the mixing ratio of the Mg(OH)₂ particles relative to 100 parts by mass of the α-Al₂O₃ particles was changed to 32 parts by mass. As a result of the SEM observation, the number of the second inorganic particles forming the single projection per predetermined area (100 μm×100 μm) was 10. An average height of the projections was 7 μm.

### Comparative Example 1

A secondary battery was produced and evaluated in the same manner as in Example 1 except that, in the production of the separator, the Mg(OH)₂ particles were not mixed.

### Comparative Example 2

A secondary battery was produced and evaluated in the same manner as in Example 1 except that, in the production of the separator, the mixing ratio of the Mg(OH)₂ particles relative to 100 parts by mass of the α-Al₂O₃ particles was changed to 2 parts by mass. As a result of the SEM observation, the number of the second inorganic particles forming the projection per predetermined area (100 μm×100 μm) was 6.

### Comparative Example 3

A secondary battery was produced and evaluated in the same manner as in Example 1 except that, in the production of the separator, the mixing ratio of the Mg(OH)₂ particles relative to 100 parts by mass of the α-Al₂O₃ particles was changed to 18 parts by mass. As a result of the SEM observation, the number of the second inorganic particles forming the projections per predetermined area (100 μm×100 μm) was 45.

Table 1 shows the evaluation results of the secondary batteries according to 5 Examples and Comparative Examples. Table 1 also shows the types and the D50 of the first inorganic particles and the second inorganic particles, and the number of the second inorganic particles forming the projections per predetermined area (100 μm×100 μm).

TABLE 1

| | | | | | Number | |
|---|---|---|---|---|---|---|
| | | | | | of second | Changing |
| | First | | Second | | inorganic | rate of |
| | inorganic | | inorganic | | particles | separator |
| | particles | | particles | | per pre- | thick- |
| | | D50 | | D50 | determined | ness |
| | Type | [μm] | Type | [μm] | area | [%] |
| Example 1 | α-Al₂O₃ | 0.7 | Mg (OH)₂ | 5 | 10 | 25 |
| Example 2 | α-Al₂O₃ | 0.7 | Mg (OH)₂ | 5 | 16 | 20 |
| Example 3 | α-Al₂O₃ | 0.7 | Mg (OH)₂ | 5 | 35 | 18 |
| Example 4 | α-Al₂O₃ | 0.7 | Mg (OH)₂ | 4 | 26 | 20 |
| Example 5 | α-Al₂O₃ | 0.7 | Mg (OH)₂ | 7 | 28 | 25 |
| Example 6 | α-Al₂O₃ | 0.7 | Mg (OH)₂ | 10 | 10 | 23 |
| Comparative | α-Al₂O₃ | 0.7 | Mg (OH)₂ | — | — | 50 |
| Example 1 | | | | | | |
| Comparative | α-Al₂O₃ | 0.7 | Mg (OH)₂ | 5 | 6 | 45 |
| Example 2 | | | | | | |
| Comparative | α-Al₂O₃ | 0.7 | Mg (OH)₂ | 5 | 45 | 44 |
| Example 3 | | | | | | |

The secondary batteries of Examples exhibit a low changing rate of the separator thickness compared with the secondary battery of Comparative Example 1. Meanwhile, the secondary batteries of Comparative Examples 2 and 3 exhibit a same level of the changing rate of the separator thickness as the secondary battery of Comparative Example 1. Therefore, it is understood that the filler layer including the second inorganic particles so that the number of the second inorganic particles forming the projections per predetermined area is greater than or equal to 10 and less than or equal to 35 inhibits the plastic deformation of the separator.

The present disclosure will be further described with the following embodiments.

### Constitution 1

A non-aqueous electrolyte secondary battery, comprising:

an electrode assembly in which a positive electrode and a negative electrode are wound with a separator interposed therebetween;

a non-aqueous electrolyte; and

an exterior housing can that houses the electrode assembly and the non-aqueous electrolyte, wherein

the separator has a substrate layer and a filler layer formed on at least one surface of the substrate layer,

the filler layer includes first inorganic particles and second inorganic particles having an average particle diameter larger than that of the first inorganic particles, and has projections formed with the second inorganic particles, and

greater than or equal to 10 and less than or equal to 35 of the second inorganic particles forming the projections are detected with a scanning electron microscope in a region of 100 μm×100 μm on a surface of the filler layer.

### Constitution 2

The non-aqueous electrolyte secondary battery according to Constitution 1, wherein an average height of the projections is greater than or equal to 1 μm and less than or equal to 9 μm relative to a surface of a part adjacent to the projections in the filler layer.

### Constitution 3

The non-aqueous electrolyte secondary battery according to Constitution 1 or 2, wherein an average particle diameter of the first inorganic particles is greater than or equal to 0.3 μm and less than or equal to 0.8 μm, and an average particle diameter of the second inorganic particles is greater than or equal to 3 μm and less than or equal to 10 μm.

### Constitution 4

The non-aqueous electrolyte secondary battery according to any one of Constitutions 1 to 3, wherein the second inorganic particles forming the projections contact with the substrate layer.

### Constitution 5

The non-aqueous electrolyte secondary battery according to any one of Constitutions 1 to 4, wherein a material of the second inorganic particles is at least one selected from the group consisting of an oxide, a sulfate, and a hydroxide.

### REFERENCE SIGNS LIST

10 Secondary battery, 11 Positive electrode, 12 Negative electrode, 13 Separator, 13a Substrate layer, 13b Filler layer, 14 Electrode assembly, 15 Exterior housing can, 16 Sealing assembly, 17, 18 Insulating plate, 19 Positive electrode lead, 20 Negative electrode lead, 21 Grooved portion, 22 Filter, 23 Lower vent member, 24 Insulating member, 25 Upper vent member, 26 Cap, 26a Opening, 27 Gasket, 30 First inorganic particle, 32 Second inorganic particle

1. A non-aqueous electrolyte secondary battery, comprising:
an electrode assembly in which a positive electrode and a negative electrode are wound with a separator interposed therebetween;
a non-aqueous electrolyte; and
an exterior housing can that houses the electrode assembly and the non-aqueous electrolyte, wherein
the separator has a substrate layer and a filler layer formed on at least one surface of the substrate layer,
the filler layer includes first inorganic particles and second inorganic particles having an average particle diameter larger than that of the first inorganic particles, and has projections formed with the second inorganic particles, and
when a surface of the filler layer is observed with a scanning electron microscope, greater than or equal to 10 and less than or equal to 35 of the second inorganic particles forming the projections are detected in a region of 100 μm×100 μm.

2. The non-aqueous electrolyte secondary battery according to claim 1, wherein an average height of the projections is greater than or equal to 1 μm and less than or equal to 9 μm relative to a surface of a part adjacent to the projections in the filler layer.

3. The non-aqueous electrolyte secondary battery according to claim 1, wherein an average particle diameter of the first inorganic particles is greater than or equal to 0.3 μm and less than or equal to 0.8 μm, and an average particle diameter of the second inorganic particles is greater than or equal to 3 μm and less than or equal to 10 μm.

4. The non-aqueous electrolyte secondary battery according to claim 1, wherein the second inorganic particles forming the projections contact with the substrate layer.

5. The non-aqueous electrolyte secondary battery according to claim 1, wherein a material of the second inorganic particles is at least one selected from the group consisting of an oxide, a sulfate, and a hydroxide.
